(19) United States
(12) Patent Application Publication
(10) Pub. No.: US 2026/0023847 A1
(43) Pub. Date: Jan. 22, 2026

(54) METHOD FOR DETECTING ATTACKS ON A COMPUTER SYSTEM

(71) Applicant: Robert Bosch GmbH, Stuttgart (DE)

(72) Inventors: Max Camillo Eisele, Ludwigsburg (DE); Christopher Huth, Heilbronn (DE); Gunter Finn, Stuttgart (DE)

(21) Appl. No.: 19/263,607

(22) Filed: Jul. 9, 2025

(30) Foreign Application Priority Data
Jul. 22, 2024 (DE) 10 2024 206 859.4

(51) Int. Cl. G06F 21/55

(52) U.S. Cl. CPC G06F 21/554; G06F 2221/034

(57) ABSTRACT

A method for detecting attacks on a computer system. The method includes ascertaining an input grammar, according to which a program running on the computer system processes inputs, by observing how the program processes a set of inputs; receiving one or more further inputs to the program; checking whether the ascertained input grammar can generate the one or more further inputs; and triggering a security measure depending on whether the ascertained input grammar can generate the one or more further inputs.

### FIELD

The present disclosure relates to methods for detecting attacks on a computer system.

### BACKGROUND INFORMATION

A data processing system performs tasks according to the IPO principle of input-process-output. For example, a simple heating control system measures the current temperature (input), calculates the distance to the desired temperature (processing), and switches on the heating when needed (output). In reality, such control systems use a number of sensors (inputs) but generally also have extensive diagnostic capabilities, which in turn work according to the IPO principle.

Every input option carries the risk that an attacker will find malicious input that causes the data processing system to work not as intended but according to the wishes of the attacker. The causes for this are software errors introduced by programmers, code generated by AI (artificial intelligence) tools, code provided by supply chains, or, simply, previously unknown attacks. Decades of research in software engineering have not led to the elimination of software errors per se. Intrusion detection capabilities are therefore desirable, i.e., mechanisms that make it possible to detect attacks and, where appropriate, initiate countermeasures, in particular on the basis of observing incoming messages (i.e., inputs), tracking them, and/or detecting differences from harmless inputs.

Germany Patent Application No. DE 10 2022 202 338 A1, hereinafter referred to as reference [1], describes a method for ascertaining an input grammar for testing a computer program.

According to various embodiments of the present invention, a method for detecting attacks on a computer system is provided, comprising ascertaining an input grammar, according to which a program running on the computer system processes inputs, by observing how the program processes a set of inputs; receiving one or more further inputs to the program; checking whether the ascertained input grammar can generate the one or more further inputs; and triggering a security measure depending on whether the ascertained input grammar can generate the one or more further inputs.

The method of the present invention described above makes it possible to detect attacks by repeatedly ascertaining an input grammar, which can help secure any long-running data processing system (e.g., one dedicated to a specific task), e.g., control devices for motor vehicles, industrial control systems, and smart devices (IOT). Other use cases include data processing systems that implement pods, e.g., in a Kubernetes environment, or microservices.

As a security measure, for example, an alarm signal is issued, a port is blocked (e.g., a port through which the computer system has received a (further) input (in the form of a message) that cannot be generated by the ascertained grammar, a firewall is configured, an account is blocked (e.g., from which an input that cannot be generated by the ascertained grammar was received), etc.). In the case that the computer system is a control unit of a robot device, such as a vehicle, safe operation can be triggered, e.g., stopping the vehicle or providing only very limited functions (“limp home”), etc.

Various exemplary embodiments of the present invention are specified below.

Exemplary embodiment 1 is a method for detecting attacks on a computer system, as described above.

Exemplary embodiment 2 is a method according to exemplary embodiment 1, wherein ascertaining the input grammar is ascertaining a first version of the input grammar, and wherein checking whether the ascertained input grammar can generate the one or more further inputs comprises ascertaining a second version of the input grammar by observing how the program processes the one or more further inputs, comparing the first version of the input grammar with the second version of the input grammar, and determining that the ascertained input grammar cannot generate the one or more inputs in response to the first version of the input grammar differing from the second version of the input grammar.

This process can be performed repeatedly (i.e., first, a third version of the input grammar is also ascertained and compared with the second version, etc. In each repetition, the ascertained grammar (i.e., the one ascertained by observing the set of inputs, which are, for example, the inputs received up to that point, plus any test inputs, if applicable) corresponds to the version ascertained up to that point (i.e., last).

In other words, versions of the input grammar that describe the behavior of the computer program are repeatedly ascertained, and attacks are detected on the basis of differences between the different versions. This makes continuous monitoring possible.

The second version of the input grammar can be ascertained on the basis of the first version of the input grammar or on the basis of intermediate results of the ascertainment of the first version of the input grammar (e.g., parse trees). This allows new versions of the grammar to be ascertained with little effort, and efficient monitoring with regard to possible attacks can thus be implemented.

Exemplary embodiment 3 is a method according to exemplary embodiment 2, comprising triggering the security measure in response to a measure of the difference between the first version of the input grammar and the second version of the input grammar exceeding a specified threshold.

By setting the specified threshold such that small differences in the versions of the grammar do not result in a security measure, false positives can be avoided.

Exemplary embodiment 4 is a method according to exemplary embodiment 3, wherein the measure of the difference depends on a difference in the numbers of non-terminal symbols, terminal symbols, and/or production rules of the first version of the input grammar and of the second version of the input grammar.

This makes it possible to easily assess the difference between the two versions of the grammar. For example, the measure may be given by one or more of the differences in the numbers of non-terminal symbols, terminal symbols and/or production rules and may accordingly be ascertained from one or more of these differences, which are easily calculated.

Exemplary embodiment 5 is a method according to exemplary embodiment 3 or 4, comprising setting the threshold lower, the larger the set of inputs (on the basis of which the first version of the input grammar was ascertained, i.e., which were taken into account in ascertaining the grammar).

In particular, the threshold may decrease over the course of an operation in which the input grammar is repeatedly ascertained. This allows false positives to be avoided at the beginning and, after some time, when it can be assumed that the input grammar has been almost completely learned, false negatives can be avoided.

Exemplary embodiment 6 is a method according to one of exemplary embodiments 3 to 5, comprising selecting the security measure from a set of security measures depending on the measure of the difference between the first version of the input grammar and the second version of the input grammar.

For example, the larger the difference, the more stringent the triggered security measure (e.g., a warning if the difference is small, stopping the computer system if the difference is large (or e.g., a safe mode of a robot device controlled by the computer system). This takes into account how well the attack detection can be trusted: If there is a large difference between the versions of the input grammar, it is likely that an attack is actually taking place. Each security measure can be assigned a threshold, and the security measure is triggered if the difference exceeds the threshold. Like the threshold mentioned above, these thresholds can also be adjusted during operation (i.e., as the number of inputs taken into account increases).

Exemplary embodiment 7 is a computer system configured to carry out the method according to one of exemplary embodiments 1 to 6.

Exemplary embodiment 8 is a computer program comprising commands that, when executed by a processor, cause the processor to carry out a method according to one of exemplary embodiments 1 to 6.

Exemplary embodiment 9 is a computer-readable medium storing commands that, when executed by a processor, cause the processor to carry out a method according to one of exemplary embodiments 1 to 6.

In the figures, similar reference signs generally refer to the same parts throughout the various views. The figures are not necessarily true to scale, with emphasis instead generally being placed on the representation of the principles of the present invention. In the following description, various aspects are described with reference to the figures.

FIG. 1 shows a computer network 100.

The following detailed description relates to the figures, which show, by way of explanation, specific details and aspects of this disclosure in which the present invention can be executed. Other aspects may be used, and structural, logical, and electrical changes may be performed without departing from the scope of the present invention. The various aspects of this disclosure are not necessarily mutually exclusive, since some aspects of this disclosure may be combined with one or more other aspects of this disclosure to form new aspects.

Various examples are described in more detail below.

### BRIEF DESCRIPTION OF THE DRAWINGS

FIG. 1 shows a computer network.

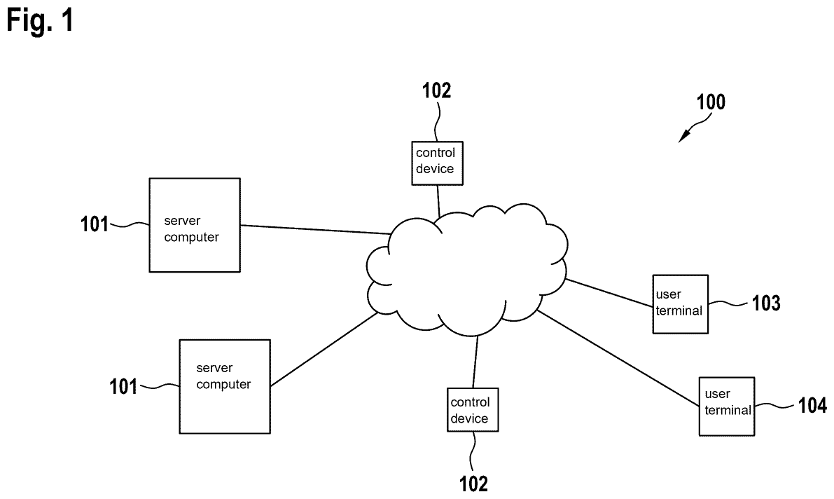

FIG. 2 shows a computer system to be protected according to one example embodiment of the present invention.

FIG. 3 illustrates an attack detection based on repeatedly ascertaining an input grammar of a software component according to one example embodiment of the present invention.

FIG. 4 is a flowchart representing a method for detecting attacks on a computer system according to one example embodiment of the present invention.

### DETAILED DESCRIPTION OF EXAMPLE EMBODIMENTS

The computer network 100 contains a plurality of data processing devices 101-104 interconnected by communication links. The data processing devices 101-104 include, e.g., server computers 101 and control devices 102 along with user terminals 103, 104.

Server computers 101 provide various services, such as Internet sites, banking portals, etc. A control device 102 is, e.g., a control unit for a robot device, such as a control unit in an autonomous vehicle. The server computers 101 and control devices 102 thus fulfill different tasks, and a server computer 101 or a control device 102 can typically be accessed from a user terminal 103, 104. This is in particular the case if a server computer 101 offers a functionality, such as a banking portal, to a user. However, a control device 102 can also allow access from outside (e.g., so that it can be configured). Depending on the task of a server computer 101 or control device 102, they can store security-related data and execute security-related tasks. Accordingly, they must be protected against attackers. For example, an attacker using one of the user terminals 104 could, through a successful attack, gain possession of confidential data (such as keys), manipulate accounts, or even manipulate a control device 102 in such a way that an accident occurs.

Modern intrusion detection systems (IDS), such as Snort, observe the data traffic and trigger a warning on the basis of predefined rules. In the automotive industry, such an intrusion detection system is generally implemented on a gateway since almost all data traffic goes through such a gateway. In the automotive sector, responses generally only comprise a warning of a potential intruder. Non-security-related systems in a cloud can also respond by blocking suspicious senders and continuing operation in a “limp home” mode.

A simple intrusion detection mechanism for protecting a data processing system (i.e., a computer system to be protected, e.g., one of the server computers 101 or one of the control devices 102) may count the number of messages received per unit of time and trigger an alarm if the number exceeds a threshold. However, such a simple heuristic leads to false positive alarms (i.e., false positives) if more messages arrive than expected for a valid reason. There are also intrusion detection methods based on machine learning, but they always face the challenge of obtaining “good” (realistic and sufficient) training data, dealing with false positive alarms, and explaining them.

In view of these difficulties, according to various embodiments, a mechanism for detecting attacks (and thus for protecting a computer system against attacks) is provided, in which, instead of analyzing the incoming messages themselves (i.e., the inputs to the computer system), it is analyzed how incoming messages are processed by the computer system.

For this purpose, a corresponding attack detection tool or a grammar ascertainment tool used by it (which is executed, for example, on the computer system to be protected) continuously ascertains a context-free grammar, which describes the input specification of the computer system, from inputs (i.e., from input messages) to the computer system (as they occur during operation of the computer system) and how the computer system processes them. The attack detection tool subsequently compares the ascertained grammar with a previously ascertained version of the grammar and checks whether and to what extent they differ. Analyzing the differences (between different versions) of a grammar instead of just the input makes it possible to draw conclusions about the input structure, increases precision, and reduces the false positive rate.

Grammars are mathematical representations of languages. A context-free grammar is a grammar in which each production rule (also called replacement rule) maps exactly one non-terminal symbol to an arbitrarily long sequence of non-terminal and terminal symbols.

As explained above, according to various embodiments, an (input) grammar for the computer system to be protected is repeatedly ascertained on the basis of inputs to the computer system and how the computer system processes them. That is to say, a grammar is ascertained which describes how the computer system handles inputs, i.e., how it breaks them down into components and distributes the individual components to different subprograms (functions, etc.), i.e., as what type of information it interprets the individual components.

In order to ascertain the input grammar, various methods can be used, in particular grammar mining, as described in reference [1]. This involves analyzing the processing of inputs (as carried out by the computer system whose input grammar is to be ascertained), the use of debug functions, such as single stepping, and of memory watchpoints, and thus ascertaining a context-free grammar. Said context-free grammar can be used, for example, to generate test data and to break down inputs into their individual components (parsing).

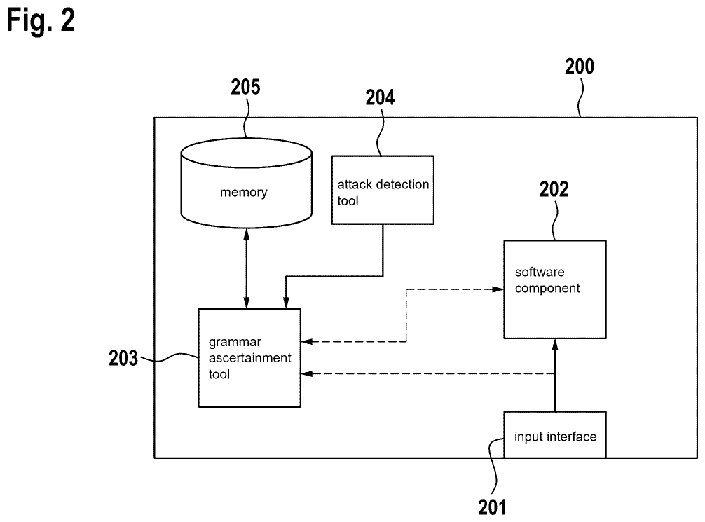

FIG. 2 shows a computer system 200 to be protected according to one embodiment.

The computer system 200 has an input interface 201 that receives inputs (e.g., via a computer network). These inputs are processed by a software component 202 of the computer system 200. A grammar ascertainment tool 203 ascertains an input grammar for the computer system 200 to be protected (i.e., ascertains a grammar that describes the syntax and/or structure according to which a software component 202 (i.e., a program) running on the computer system processes inputs) on the basis of inputs received (via the input interface) (and recorded). The grammar ascertainment tool 203 runs either as a separate task or as a separate process, preferably with a lower priority so as not to disrupt the actual operation of the computer system. The ascertainment of the grammar may, for example, also be carried out on a separate processor core of the computer system 200.

Different methods can be used to ascertain the grammar. The ascertainment of the grammar on the basis of a previously recorded set of inputs according to the aforementioned grammar mining, as described, for example, in reference [1], is carried out, for example, by the following two steps:
1) First, all inputs are traced using single stepping in order to ascertain both the control flow triggered by the input and the data watchpoints in order to determine which parts of the input are processed by which parts of the software component that processes the inputs. The traces thus ascertained are subsequently converted into multiple so-called derivation trees (also called parse trees). From the knowledge of which function of the software component that processes the inputs (in particular of an input parser) last accessed a certain part of an input, the grammar ascertainment tool 203 can derive what the part of the test input data was recognized as. This is because the input parser typically does not consider the part of the test input data any further if it has executed a function on it that has recognized this part as being of a certain type. From the information as to which part of the input parser (e.g., which function, e.g., divided into hierarchy levels of functions, e.g., given by a previously ascertained control flow graph) last accessed a part of the input data, it can therefore be deduced what the input parser recognized the part of the input data as, and the input can thus be represented in the form of a particular parse tree.
2) The nodes of the derivation trees (parse trees) are checked for compatibility in order to link them to form a grammar. Compatible nodes are nodes that are interchangeable, meaning that, when the nodes in the trees are swapped, the resulting inputs are still accepted by the program (i.e., are not rejected by the software component that processes the input). The child nodes of compatible nodes are finally translated into options of the same production rule, which is added to the grammar.

According to various embodiments, the ascertainment of the grammar is carried out repeatedly, i.e., the grammar is ascertained, for example, for a first set of inputs (which were made up to a certain point in time, e.g., received up to that point in time during operation), which provides a first version of the grammar, and, if one or more further inputs were made, the grammar is ascertained again, which provides a second version of the grammar. For example, the attack detection tool 204 triggers the grammar ascertainment tool 203 at certain points in time to re-ascertain the input grammar.

Changes in the learned grammar (e.g., from the first to the second version in the example above) are then used by an attack detection tool 204 to detect possible attacks. In other words, the grammar ascertainment tool 203 observes the incoming data traffic and ascertains (learns) a grammar on this basis (initially, for example, with harmless data, e.g., test data, before the computer system is used in a real computer network). Later, when the computer system is used in a real computer network, the grammar is further refined on the basis of incoming data traffic (and its processing by the software 202). The attack detection tool 204 then interprets a significant change in the ascertained grammar (e.g., the grammar rules) as an indication of an attack and, in response, triggers a countermeasure, for example. It should be noted that the grammar does not necessarily need to be further refined on the basis of the incoming data traffic, but it can also (e.g., first) be checked whether the previously ascertained version of the grammar can generate the incoming data traffic. If this is the case, the attack detection tool 204 interprets this as no attack, and the grammar ascertainment tool 203 can, for example, ignore the data traffic with regard to refining the grammar, for example (because there would be no difference between the grammars anyway). If the incoming data traffic cannot be generated by the previously ascertained version of the grammar, the computer system can, for example, respond by refining the grammar and assessing the difference to the previously ascertained version in order to decide whether an attack (or a suspected attack) is taking place.

For repeatedly ascertaining the grammar, for example, all derivation trees from previous ascertainments can be obtained during a (current) ascertainment of the grammar (where appropriate, together with the information about compatible nodes), which derivation trees are stored by the grammar ascertainment tool 203 in a memory 205 during each ascertainment. Thus, only the newly received inputs (since the last ascertainment) need to be analyzed, which reduces the effort required for the ascertainment.

In case too many messages arrive between the points in time of ascertainment to be able to analyze all of them, a selection of the (newly received) messages can be made and used for the (current) ascertainment of the grammar. For this purpose, messages that were already used to ascertain the previous version of the grammar can, for example, first be sorted out (in particular those that were contained in the test data used before the computer system was deployed (i.e., for example, seed inputs)). Random subsampling from the incoming messages remaining after the sorting can then be carried out. Instead of random subsampling, the grammar ascertainment tool 203 can also select more exotic messages in terms of length or content.

If the grammar ascertainment tool 203 (e.g., part of an IDS) has ascertained a new version of the (e.g., context-free) grammar on the basis of the selected incoming messages, the attack detection tool 204 compares it with a previous version (or multiple previous versions).

Since all versions of the grammar are ascertained for the same software component, the new version of the grammar is incremental, i.e., it adds new terminal symbols, non-terminal symbols or production rules to the previous version (if it differs at all from the previous version). The attack detection tool 204 can thus easily ascertain the difference between the new set of symbols (the new version of the grammar) and the previous set of symbols (the previous version of the grammar). Production rules can also be compared with one another by comparing, component by component, the lists of symbols to which the production rules map a non-terminal symbol.

If the attack detection tool 204 detects a major change in the input grammar from one version to the next in a sequence of versions of the input grammar, it interprets this as an attack. It can also check whether the current version of the input grammar contains symbols from forbidden (blacklist) regions of the software component that processes the input, and, where appropriate, interpret this as an attack (or as confirmation of a suspected attack). This could include, for example, operating system regions or functions that have nothing to do with the software component.

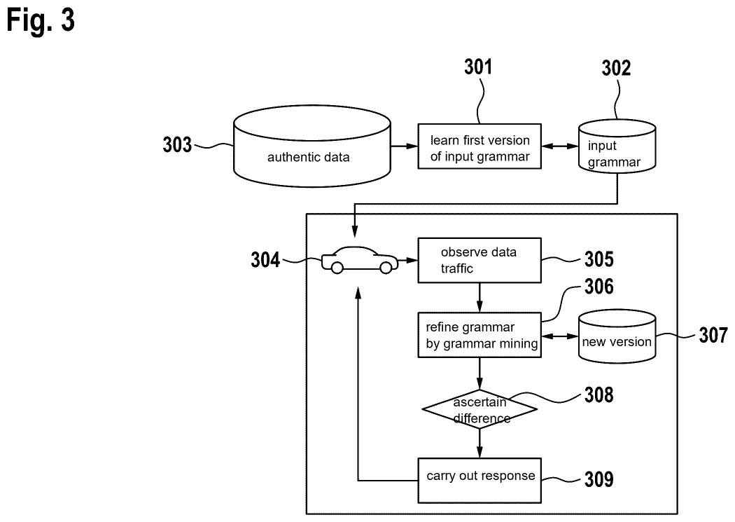

FIG. 3 illustrates an attack detection based on repeatedly ascertaining an input grammar of a software component (i.e., which describes how the software component works, i.e., which syntax and/or structure it takes as a basis for inputs for their further processing) according to one embodiment.

First, in a first step 301, a first version of the input grammar 302 can optionally be learned on the basis of previously collected, authentic data 303. In this way, high computational effort and false positive results are avoided at the beginning of the use of the software component.

In use (e.g., on a vehicle 304), in each repetition (i.e., iteration) in 305, the data traffic arriving at the software components is then observed, and the grammar is refined in 306 by grammar mining to form a new version 307 (current version for the current iteration).

Optionally, inputs that can already be parsed by the previous version of the grammar (which can be the first version 302 or the version 307 ascertained in a previous iteration) can be discarded in order to save computing time.

In 308, the difference (i.e., the delta) between the currently ascertained version 307 and the previous version is ascertained. If the difference is above a threshold, a response is carried out in 309 (which may in turn depend on the difference). Otherwise, the next iteration follows.

Metrics for grammar changes, i.e., for the difference between two versions of the grammar, are for example:
The number of newly added terminal symbols
The number of newly added production rules

The responses in the case of too large a difference are, for example (depending on the difference):
Issuing of a warning to a user (if the difference is small)
Takeover of the control by a teleoperator (if the difference is large)
Vehicle 304 goes into a safety mode (e.g., limp-home mode) (if the difference is very large).

The boundary between a difference that does not trigger any security measure, a small difference, a large difference, and a very large difference is, depending on the metric used, for example, a number of newly added terminal symbols or production rules. How exactly these thresholds are set can be set, for example, on the basis of test examples, and/or the thresholds can also be reduced during ongoing operation since it can be assumed that, after a certain period of operation, the grammar is (at least almost) correctly learned with regard to harmless inputs, i.e., correctly describes the behavior of the software component with regard to the processing of harmless inputs.

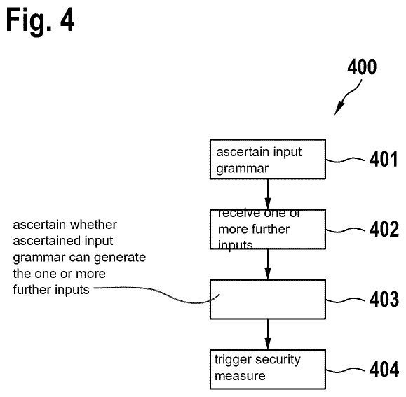

In summary, according to various embodiments, a method is provided as shown in FIG. 4.

FIG. 4 is a flowchart 400 illustrating a method for detecting (and identifying) attacks on a computer system (specifically, for detecting communication traffic for exploiting security vulnerabilities) according to one embodiment.

In 401, an input grammar, according to which a program running on the computer system processes inputs (i.e., a grammar that describes an input specification of the program running on the computer system, i.e., describes which (input) syntax and/or (input) structure the program running on the computer system takes as a basis when processing inputs), is ascertained by observing how the program processes a set of inputs.

In 402, one or more further inputs to the program are received (during operation of the computer system with the program running thereon, e.g., via a computer network to which the computer system is connected).

In 403, it is checked whether the ascertained input grammar can generate the one or more further inputs.

In 404, a security measure is triggered depending on whether the ascertained input grammar can generate the one or more further inputs (namely, if it cannot generate them, possibly taking into account further criteria (such as a sufficiently large difference between the ascertained grammar versions as described above).

The method of FIG. 4 can be carried out by one or more computers with one or more data processing units. The term “data processing unit” may be understood as any type of entity that allows for processing of data or signals. The data or signals can be treated, for example, according to at least one (i.e., one or more than one) specific function which is carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be executed (e.g., implemented) by a data processing unit by one or more specific functions that are carried out by the data processing unit.

The method is therefore in particular computer-implemented according to various embodiments.

1-9. (canceled)

10. A method for detecting attacks on a computer system, comprising the following steps:
ascertaining an input grammar, according to which a program running on the computer system processes inputs, by observing how the program processes a set of inputs;
receiving one or more further inputs to the program;
checking whether the ascertained input grammar can generate the one or more further inputs; and
triggering a security measure depending on whether the ascertained input grammar can generate the one or more further inputs.

11. The method according to claim 10, wherein the ascertaining of the input grammar includes ascertaining a first version of the input grammar, and wherein the checking of whether the ascertained input grammar can generate the one or more further inputs includes ascertaining a second version of the input grammar by observing how the program processes the one or more further inputs, comparing the first version of the input grammar with the second version of the input grammar, and determining that the ascertained input grammar cannot generate the one or more inputs in response to the first version of the input grammar differing from the second version of the input grammar.

12. The method according to claim 11, further comprising triggering the security measure in response to a measure of a difference between the first version of the input grammar and the second version of the input grammar exceeding a specified threshold.

13. The method according to claim 12, wherein the measure of the difference depends on a difference in numbers of non-terminal symbols, and/or terminal symbols, and/or production rules of the first version of the input grammar and of the second version of the input grammar.

14. The method according to claim 12, further comprising setting the threshold lower, the larger the set of inputs.

15. The method according to claim 12, further comprising selecting the security measure from a set of security measures depending on the measure of the difference between the first version of the input grammar and the second version of the input grammar.

16. A computer system configured to detect attacks on a computer system, the computer system configured to:
ascertain an input grammar, according to which a program running on the computer system processes inputs, by observing how the program processes a set of inputs;
receive one or more further inputs to the program;
check whether the ascertained input grammar can generate the one or more further inputs; and
trigger a security measure depending on whether the ascertained input grammar can generate the one or more further inputs.

17. A non-transitory computer-readable medium on which are stored commands for detecting attacks on a computer system, the commands, when executed by a processor, causing the processor to perform the following steps:
ascertaining an input grammar, according to which a program running on the computer system processes inputs, by observing how the program processes a set of inputs;
receiving one or more further inputs to the program;
checking whether the ascertained input grammar can generate the one or more further inputs; and
triggering a security measure depending on whether the ascertained input grammar can generate the one or more further inputs.
